(19) United States
(12) Patent Application Publication
(10) Pub. No.: US 2019/0141336 A1
(43) Pub. Date: May 9, 2019

(54) CHIP AND DIGITAL VIDEO SIGNAL TRANSMISSION SYSTEM

(71) Applicant: LONTIUM SEMICONDUCTOR CORPORATION, Hefei Anhui (CN)

(72) Inventors: Feng CHEN, Hefei Anhui (CN); Diansheng REN, Hefei Anhui (CN); Hongfeng XIA, Hefei Anhui (CN); Shenghui BAO, Hefei Anhui (CN); Jin SU, Hefei Anhui (CN); Changfang YUE, Shenzhen Guangdong (CN); Wenbo HE, Shenzhen Guangdong (CN)

(21) Appl. No.: 15/981,283

(22) Filed: May 16, 2018

(30) Foreign Application Priority Data
May 17, 2017 (CN) 201710348504.6
May 17, 2017 (CN) 201720557401.6
Jul. 24, 2017 (TW) 106124704

(51) Int. Cl. H04N 19/146; H04N 19/42; H04N 19/186; H04N 19/85

(52) U.S. Cl. CPC H04N 19/146; H04N 19/85; H04N 19/186; H04N 19/42

(57) ABSTRACT

A chip is provided, which includes a first receiving module, a protocol logic module, a color space conversion module, a compression module and a transmitting module. The first receiving module is configured to receive a digital video signal. The protocol logic module is configured to perform protocol unpacking on the digital video signal to obtain a video code stream. The color space conversion module is configured to perform color space conversion on the video code stream. The compression module is configured to perform lossless compression on the video code stream obtained by the color space conversion. The transmitting module is configured to transmit the video code stream obtained by the lossless compression.

### CROSS REFERENCE TO RELATED APPLICATION

The present application claims priority under 35 U.S.C. § 119 to CN Application No. 201710348504.6 and CN Application No. 201720557401.6 both filed May 17, 2017; and TW Application No. 106124704 filed Jul. 24, 2017; the entire content of which is incorporated herein by reference.

### FIELD

The present disclosure relates to the technical field of video signal transmission, and in particular to a chip and a digital video signal transmission system including the chip.

### BACKGROUND

With continuous popularization of digital video technologies and products, a demand for a long-distance transmission of a digital video signal is increasing.

The digital video signal may be attenuated during a transmission, resulting that a transmission distance may not be too long. Particularly, high-definition digital video signals such as High-Definition Media Interface (HDMI) signals and Display Port (DP) signals, are exponentially attenuated in transmission cables. High-definition HDMI signals and DP signals, in particularly to ultra-high-definition 4K signals and 8K signals may only be transmitted for a few meters distance with expensive cables, which greatly limits the application of uncompressed and lossless high-definition display of signals such as HDMI signals and DP signals.

### SUMMARY

In view of this, a chip and a digital video signal transmission system are provided according to the present disclosure so as to increase a transmission distance of a digital video signal.

In order to achieve the above purpose, following technical solutions are adopted in the present disclosure.

A chip is provided, which includes a first receiving module, a protocol logic module, a color space conversion module, a compression module and a transmitting module. The first receiving module is configured to receive a digital video signal. The protocol logic module is configured to perform protocol unpacking on the digital video signal to obtain a video code stream. The color space conversion module is configured to perform color space conversion on the video code stream. The compression module is configured to perform lossless compression on the video code stream obtained by the color space conversion. The transmitting module is configured to transmit the video code stream obtained by the lossless compression.

Optionally, the chip further includes an enhancement module configured to pre-emphasize the video code stream obtained by the lossless compression transmitted from the transmitting module.

Optionally, the transmitting module is a parallel-to-serial conversion module.

Optionally, the parallel-to-serial conversion module is a high-speed differential serial interface.

The above is a first technical solution of the chip, corresponding to the chip provided according to the above technical solution, a second technical solution of the chip is further provided according to the present disclosure as follows.

A chip is provided, which includes a second receiving module, a decompression module, a color space conversion module, a transmitter logic module and an output module. The second receiving module is configured to receive a video code stream obtained by lossless compression. The decompression module is configured to decompress the video code stream obtained by the lossless compression. The color space conversion module is configured to perform color space conversion on the decompressed video code stream. The transmitter logic module is configured to edit the video code stream obtained by the color space conversion to obtain a digital video signal conforming to a digital video signal protocol. The output module is configured to output the digital video signal.

Optionally, the chip further includes a signal amplifying module configured to amplify a pre-emphasized video code stream before the second receiving module receives the video code stream.

Optionally, the second receiving module is a serial interface, and the chip further includes a serial-to-parallel conversion module configured to convert a serial signal received by the serial interface to a parallel signal and transmit the parallel signal to the decompression module.

Optionally, the serial interface is a universal high-speed differential serial interface.

Based on the chip provided according to the above technical solution, a technical solution of a digital video signal transmission system is further provided according to the present disclosure as follows.

A digital video signal transmission system is provided, which includes a transmitter and a receiver. The transmitter is the chip according to the first technical solution, the receiver is the chip according to the above second technical solution. The transmitter and the receiver are connected via a data transmission medium.

Optionally, the data transmission medium is any one of a transmission cable for a digital video signal, a network cable used for network connection and a chip having functions of cut-through and switching of high bandwidth data.

As compared with the conventional technology, the present disclosure has following advantages. With the chip and the digital video signal transmission system including the chip according to the present disclosure, color space conversion is performed on a digital video signal such as HDMI signals or DP signals at a transmitter of the digital video signal, the impact of the color space conversion on video image quality may be negligible. Then (low) lossless video code stream compression is performed on the digital video signal obtained by the color space conversion, maximum compression ratio of lossless video code stream compression may reach 8:1. A data rate is reduced through the (low) lossless video code stream compression technology, thereby reducing signal attenuation in a video code stream transmission and increasing the transmission distance by more than 10 times. Lossless decompression is performed on the video code stream at the receiver, in this case, a resolution of the image is back to an original state and an original image quality is maintained. Therefore, the chip and the digital video signal transmission system including the chip according to the present disclosure can increase a transmission distance of a digital video signal without affecting the video image quality.

The digital video signal transmission system according to the present disclosure may be conveniently applied to application scenarios requiring the long distance transmission, such as internet cafes, venues, homes, subways, high-speed trains, multimedia classrooms, so as to achieve enormous economic value and social value.

### BRIEF DESCRIPTION OF THE DRAWINGS

In order to clearly understand specific embodiments of the present disclosure, the drawings required in the description of the specific embodiments are briefly described below.

FIG. 1 is a schematic block diagram of a digital video signal transmission system according to an embodiment of the present disclosure;

FIG. 2 is a schematic structural diagram of a transmitter according to an embodiment of the present disclosure; and

FIG. 3 is a schematic structural diagram of a receiver according to an embodiment of the present disclosure.

### DETAILED DESCRIPTION OF EMBODIMENTS

Before describing specific embodiments of the present disclosure, technical terms and corresponding English full names and English abbreviations used in a description of the specific embodiments of the present disclosure are introduced first.

HDMI: High-Definition Media Interface;

DP (Display Port) is a high-definition display port;

CSC (Color Space Conversion) is a process of converting or representing color data in a color space to/as corresponding data in another color space, that is, data in different color spaces is used to represent the same color;

DSC (Digitial Stream Compression) is (low) digital video code stream compression;

SERDES (Serializer and Deserializer) is a universal high-speed differential serial interface;

ASIC (Application Specific Integrated Circuit) is a special chip; and

FPGA (Field Programmable Gate Array) is a programable logic chip.

There are many standard digital video signal transmission formats for a signal transmitted between a video signal source and a display device, which include: DVI (Digital Visual Interface), HDMI, Display Port and SDI (Serial Digital Interface).

In the embodiment of the present disclosure, the digital video signal may be a digital video signal in any of the above transmission formats.

The digital video signal transmission system according to the embodiment of the present disclosure is used for transmitting a digital video signal from a video signal source to a display device and playing video data corresponding to the digital video signal at the display device.

A technical principle of the digital video signal transmission system according to the embodiment of the present disclosure is to reduce a code rate without affecting a video image quality through performing color space conversion and (low) digital video code stream lossless compression on a video code stream obtain by protocol unpacking, thereby lowering a bandwidth demand for a data transmission and increasing a transmission distance.

Specific embodiments of a chip and a digital video signal transmission system including the chip according to the present disclosure are described in detail in conjunction with the drawings hereinafter.

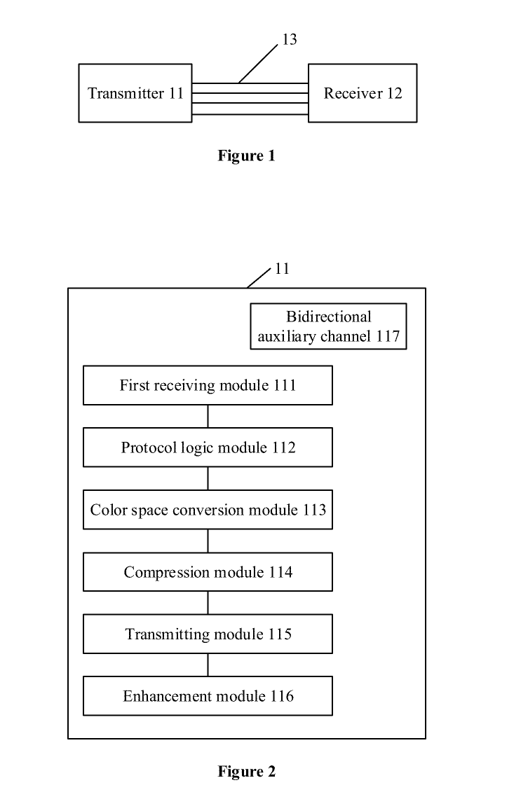

FIG. 1 is a schematic block diagram of a digital video signal transmission system according to an embodiment of the present disclosure. As shown in FIG. 1, the digital video signal transmission system includes: a transmitter 11, a receiver 12 and a data transmission medium 13 used for connecting the transmitter 11 and the receiver 12. The data transmission medium 13 is configured to transmit video data from the transmitter 11 to the receiver 12.

A specific structure of the transmitter 11 is shown in FIG. 2, which includes: a first receiving module 111, a protocol logic module 112, a color space conversion module 113, a compression module 114 and a transmitting module 115.

The first receiving module 111 is configured to receive a digital video signal. More specifically, the first receiving module 111 is configured to receive the digital video signal from a video signal source. The video signal source may be a camera as an example.

The protocol logic module 112 is configured to perform protocol unpacking on the digital video signal to obtain a video code stream. The digital video signal is a signal with a certain video protocol standard format. For example, HDMI signal is a signal conforming to the HDMI protocol. In order to obtain an original video code stream, the protocol logic module 112 has to perform the protocol unpacking on the digital video signal received by the first receiving module 111 to obtain the original video data, i.e. the video code stream.

The color space conversion module 113 is configured to perform the color space conversion on the video code stream.

The compression module 114 is configured to perform the lossless compression on the video code stream obtained by the color space conversion.

When the color space conversion module 113 performs the color space conversion on the video code stream, effect of the color space conversion on the video image quality may be negligible, therefore, the color space conversion technology may not adversely affect the video image quality. In practice, an engineer may select a conversion type of the color space conversion based on a resolution requirement of the display device of the receiver 12, a type and a length of the data transmission medium 13 and a video format supported by the signal source of the transmitter 11. For example, the conversion type of the color space conversion may be 4:4:4 to 4:2:2, or may be 4:4:4 to 4:2:0. A data bandwidth may be reduced through the color space conversion.

Based on the color space conversion, a (low) digital video code stream compression is performed on the video code stream, thereby reducing a bandwidth of the video code stream and ensuing high image quality. During a process of performing the (low) digital video code stream compression on the video code stream, a compression ratio (such as 1, 2, 3, 4) of the (low) digital video code stream compression may be selected.

The color space conversion technology and the (low) digital video code stream compression technology are adopted in the present disclosure, which may compress the video code stream with a high bandwidth by 2 to 8 times, where the maximum ratio may reach 8:1. Therefore, a video data rate may be reduced at the transmitter 11, thereby reducing signal attenuation in the video code stream transmission, in this case, the transmission distance is increased by more than 10 times.

The transmitting module 115 is configured to transmit the video code stream obtained by the lossless compression to the receiver 12.

In order to reduce the quantity of transmission cables of the data transmission medium 13, the transmitting module 115 may be a parallel-to-serial conversion module. In this way, before the video code stream transmission, a parallel signal of the video code stream is firstly converted to a serial signal. In this way, the data transmission medium 13 may complete transmission of the video code stream with one transmission cable.

Moreover, in the transmitter 11, after the color space conversion module 113 performs the color space conversion on the video code stream and the compression module 114 performs the lossless compression on the video code stream, the code rate may be reduced in a digital domain, thereby reducing a code stream demand. Therefore, a transmission physical layer of the transmitting module 115 may adopt a universal high-speed differential serial interface. The high-speed differential serial interface generally has 8b/10b (bit) coding, a stable direct current level is maintained, a differential current driving is used and terminations at both ends are included. Therefore, anti-interference and anti-reflection capabilities are relatively good and alternative current coupling may also avoid issues of I/O compatibility. This physical layer may achieve a very high data rate. Therefore, signal transmission stability and a low error rate are well ensured by using this universal high-speed differential serial interface.

As an example, the high-speed differential serial interface may be four high-speed differential serial interfaces with differential driving, which may be used for transmitting four channels of data signals or may be used for transmitting three channels of data signals and one channel of a clock signal.

In addition, as a specific embodiment of the present disclosure, in order to increase a transmission distance of the digital video signal, the transmitter 11 may be further include an enhancement module 116 configured to pre-emphasize the video code stream obtained by the lossless compression transmitted from the transmitting module 115. In this way, in this specific embodiment, a longer distance transmission of the digital video signal can be achieved by using a transmission system with a relative simple structure without increasing a video transmission delay.

As another embodiment of the present disclosure, the transmitter 11 may also include a bidirectional auxiliary channel 117 configured to transmit parameter information of the audio/video supported by a downstream display device and a control signal for controlling the downstream display device. The parameter information of the audio/video supported by the downstream display device may be a format, a rate of the audio/video.

In the embodiment of the present disclosure, the transmitter 11 may have a chip structure. As an example, the chip may be an ASIC chip or a FPGA chip.

Moreover, various function modules in the transmitter 11 in the embodiment of the present disclosure may be achieved through a circuit structure or a software program module.

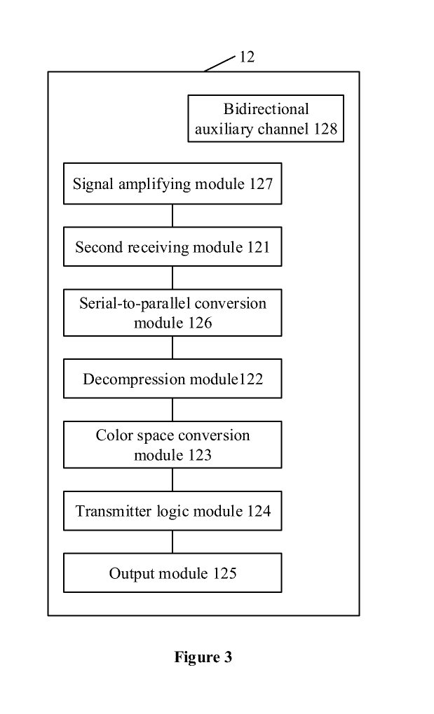

The above is an introduction of a structure and functions of the transmitter 11. The structure and functions of the receiver 12 are described hereinafter. Corresponding to the transmitter 11, a specific structure of the receiver 12 is shown in FIG. 3, the receiver 12 includes a second receiving module 121, a decompression module 122, a color space conversion module 123, a transmitter logic module 124 and an output module 125.

The second receiving module 121 is configured to receive a video code stream obtained by lossless compression from the transmitting module 115 of the transmitter 11.

The decompression module 122 is configured to decompress the video code stream obtained by the lossless compression.

The color space conversion module 123 is configured to perform the color space conversion on the decompressed video code stream.

The transmitter logic module 124 is configured to edit the video code stream obtained by the color space conversion to obtain a digital video signal conforming to a digital video signal protocol.

The output module 125 is configured to output the digital video signal to a downstream display device, so as to transmit the digital video signal to the downstream display device for play.

It should be noted that, in the digital video signal transmission system according to the embodiment of the present disclosure, the structure and functions of the receiver 12 correspond to the structure and functions of the transmitter 11. For example, in a case that a CSC conversion mechanism and a compression ratio of DSC in the transmitter 11 are selected, a configuration corresponding to the configuration of the transmitter 11 must be set in the receiver 12 so that the video code stream may be properly recovered and played.

For example, in a case where the compression ratio of the compression module 114 in the transmitter 11 is 4:1, a decompression ratio of the decompression module 122 in the receiver 12 is 1:4.

In a case where the transmitting module 115 in the transmitter 11 is the parallel-to-serial conversion module, the second receiving module 121 in the receiver 12 is a serial interface. In such specific embodiment, in order to improve data transmission efficiency, the receiver 12 may further include a serial-to-parallel conversion module 126 configured to convert a serial signal received by the serial interface to a parallel signal and transmit the parallel signal to the decompression module 122. As an example, the serial interface may be a universal high-speed differential serial interface. The high-speed differential serial interface may be used for transmitting four channels of data signals or may be used for transmitting three channels of data signals and one channel of a clock signal.

In a case where the transmitter 11 includes the enhancement module 116, in order to achieve balance of the signal, the receiver 12 includes a signal amplifying module 127 configured to amplify a pre-emphasized video code stream before the second receiving module 121 receives the video code stream.

In order to transmit the digital video signal to the downstream display device in the digital video signal transmission system, the transmitter logic module 124 in the receiver 11 is used to edit the video code stream obtained by the color space conversion to obtain the digital video signal conforming to the digital video signal protocol, such as the HDMI signal conforming to the HDMI protocol.

As a specific example of the present disclosure, the receiver 12 may further include a bidirectional auxiliary channel 128, configured to transmit parameter information of the audio/video supported by a downstream display device and a control signal for controlling the downstream display device. The parameter information of the audio/video supported by the downstream display device may be a format, a rate of the audio/video.

It should be noted that, in the embodiment of the present disclosure, the bidirectional auxiliary channel 117 arranged in the transmitter 11 is communicated with the bidirectional auxiliary channel 128 arranged in the receiver 12.

The above is an introduction of the specific structure and functions of the receiver 12 according to the embodiment of the disclosure. Moreover, various function modules in the transmitter 12 in the embodiment of the present disclosure may be achieved through a circuit structure or a software program module.

In the embodiment of the present disclosure, the data transmission medium 13 may be a signal transmission cable corresponding to a standard protocol of the digital video signal, or a network cable used for network connection, or a chip having functions of cut-through and switching of high bandwidth data.

Moreover, the transmitter 11 and the receiver 12 are welded on a printed wiring board. Therefore, the data transmission medium 13 may further be a differential pair routing arranged on the printed wiring board.

The data transmission medium 13 is a signal transmission cable corresponding to the standard protocol of the digital video signal. Specifically, in a case where the standard protocol of the digital video signal is HDMI, the transmission cable is a HDMI standard transmission cable; in a case where the standard protocol of the digital video signal is DP, the transmission cable is a DP standard transmission cable.

In a case where the data transmission medium 13 is a network cable used for network connection, a CAT6 or CAT6e cable may be adopted.

The above is a specific embodiment of the digital video signal transmission system according to the embodiment of the present disclosure. In the digital video signal transmission system, color space conversion is performed on a digital video signal at a transmitter of the digital video signal, the impact of the color space conversion on video image quality may be negligible. Then (low) lossless video code stream compression is performed on the digital video signal obtained by the color space conversion, maximum compression ratio of lossless video code stream compression may reach 8:1. A data rate is reduced through the (low) lossless video code stream compression technology, thereby reducing signal attenuation in a video code stream transmission and increasing the transmission distance by more than 10 times. Lossless decompression is performed on the video code stream at the receiver, in this case, a resolution of the image is back to an original state and an original image quality is maintained. Therefore, the chip and the digital video signal transmission system including the chip according to the present disclosure can increase a transmission distance of a digital video signal without affecting the video image quality.

Moreover, in the transmitter 11 of the digital video signal transmission system according to the present disclosure, the compression module 114 may perform lossless compression on the video code stream. A bandwidth of the compressed video code stream is reduced, so that a transmission distance of the signal is increased. A manner of reducing the bandwidth through the video code stream lossless compression technology leads to less power consumption.

Moreover, in a case where a high-definition digital video signal, such as a high-definition HDMI signal or a high-definition DP signal is transmitted by using the digital video signal transmission system, the bandwidth of the video data may be properly reduced through the color space conversion technology on the premise that the effect on the video image quality is negligible. On this basis, the lossless (low) digital video code stream compression technology is used, a data bandwidth compression ratio may be up to 8, so that a data bandwidth of the actual transmitted high-definition digital video signal is close to a bandwidth of a standard-definition video code stream. Therefore, the transmission system may achieve a long distance transmission of the high-definition digital video signal at a low cost and without increasing a video transmission delay.

The digital video signal transmission system according to the present disclosure may be conveniently applied to application scenarios requiring the long distance transmission, such as internet cafes, venues, homes, subways, high-speed trains, multimedia classrooms, so as to achieve enormous economic value and social value.

In order to highlight an effect of the digital video signal transmission system provided by the present disclosure, the technical solution of the digital video signal transmission system according to the disclosure is compared with several technical solutions for increasing a transmission distance in conventional technology.

In a first technical solution in the conventional technology, a longer signal transmission distance is realized by directly enhancing (pre-emphasizing) a high-frequency signal of the digital video signal such as the high-definition HDMI and DP signals at the receiver and amplifying the high-frequency signal (signal balance) at the receiver. For this transmission method, a signal bandwidth is not changed, and a transmission distance of the signal is increased limitedly due to effect of signal attenuation, noises in a signal channel and external noises.

The transmission system provided in the present disclosure reduces the signal bandwidth through the lossless video code stream compression technology. In this way, as compared with the first technical solution in the conventional technology, the transmission system provided in the present disclosure may transmit the digital video signal for a longer distance.

In a second technical solution in the conventional technology, a digital video signal, such as the HDMI protocol signal and the DP protocol signal, is unpacked and is converted to a SERDES signal. An optical module is driven and an optical fiber is used as a transmission medium because a loss of optical fiber transmission is low, thereby achieving a long distance transmission (multimode optical fiber can achieve a transmission distance of hundreds of meters; single model optical fiber can achieve a transmission distance of tens of kilometers). However, a way with signal conversion, optical driving and the optical fiber is costly, has poor installation flexibility, and cannot achieve bidirectional transmission of a control signal.

As compared with the second technical solution in the conventional technology, the transmission system provided in the present disclosure has not to be provided with an optical module, the installation flexibility of the transmission system in the present disclosure is higher and the bidirectional transmission of the control signal may be achieved.

In a third technical solution in the conventional technology, a digital video signal, such as the HDMI protocol signal and the DP protocol signal, is unpacked and then is compressed (JPEG, H.264). Then the compressed digital video signal is converted to a network protocol and transmitted through a network cable. The data is received at the receiver, and then video decompression is performed on the data, and the decompressed data is converted to the HDMI protocol signal or the DP protocol signal. Advantages of this technical solution is that the compression ratio is high, a demand for a transmission bandwidth is low, a universal TCP/IP protocol transmission is adopted, it is possible to support a display of multiple receivers and the transmission of bidirectional control signals through a network switch. Disadvantages of the technical solution is that video quality is affected seriously, in particularly to moving pictures, the video may be stopped. In addition, compression and decompression processes take a long time, therefore, there is a significant time delay, which can not be applied to application scenarios that are strict with the time delay, such as reversing videos and games.

The transmission system provided in the present disclosure adopts the color space conversion technology which have little effect on the video image quality. In addition, the compression technology adopts the (low) lossless video code stream compression technology, the compression and decompression processes take a short time, therefore, the transmission system provided in the present disclosure has no time delay. Therefore, the digital video signal transmission system provided in the present disclosure may be applied to the application scenarios that are strict with the time delay, such as the reversing videos and games.

In a fourth technical solution in the conventional technology, a digital video signal such as the HDMI protocol signal and the DP protocol signal is unpacked. A compression process is not performed on the video code stream obtained by protocol unpacking. The signal is coded in a physical layer of signal transmission, such as multi-level coding (PAM4, 4-level or level encoding of more levels), to reduce a bandwidth of a transmitted signal, and to increase a transmission distance. This method has high power consumption, a high chip cost, a high requirement for cables and poor stability.

In the transmission system of the present disclosure, in a method for increasing a transmission distance through reducing a bandwidth by performing the low lossless compression on the video code stream, power consumption and a chip cost are low. The method provided in the present disclosure has a low requirement for a cable of a data transmission medium, and a high transmission stability. Therefore, as compared with fourth technical solution in the conventional technology, the present disclosure may achieve a stable long distance transmission of the digital video signal in particular to a high-definition digital video signal on a premise of the low power consumption and the low cost.

Based on the above analysis, the digital video signal transmission system provided in the present disclosure may achieve effects of a long transmission distance, a low hardware cost, a convenient use, high image quality, low power consumption and a stable transmission at the same time.

The specific embodiments of the present disclosure are described above.

1. A chip, comprising:
a first receiving module, configured to receive a digital video signal;
a protocol logic module, configured to perform protocol unpacking on the digital video signal to obtain a video code stream;
a color space conversion module, configured to perform color space conversion on the video code stream;
a compression module, configured to perform lossless compression on the video code stream obtained by the color space conversion; and
a transmitting module, configured to transmit the video code stream obtained by the lossless compression.

2. The chip according to claim 1, further comprising:
an enhancement module, configured to pre-emphasize the video code stream obtained by the lossless compression transmitted from the transmitting module.

3. The chip according to claim 1, wherein the transmitting module is a parallel-to-serial conversion module.

4. The chip according to claim 3, wherein the parallel-to-serial conversion module is a high-speed differential serial interface.

5. A chip, comprising:
a second receiving module, configured to receive a video code stream obtained by lossless compression;
a decompression module, configured to decompress the video code stream obtained by the lossless compression;
a color space conversion module, configured to perform color space conversion on the decompressed video code stream;
a transmitter logic module, configured to edit the video code stream obtained by the color space conversion to obtain a digital video signal conforming to a digital video signal protocol; and
an output module, configured to output the digital video signal.

6. The chip according to claim 5, further comprising:
a signal amplifying module configured to amplify a pre-emphasized video code stream before the second receiving module receives the video code stream.

7. The chip according to claim 5, wherein the second receiving module is a serial interface, and the chip further comprises:
a serial-to-parallel conversion module, configured to convert a serial signal received by the serial interface to a parallel signal and transmit the parallel signal to the decompression module.

8. The chip according to claim 7, wherein the serial interface is a universal high-speed differential serial interface.

9. A digital video signal transmission system, comprising: a transmitter and a receiver, wherein
the transmitter comprises:
a first receiving module, configured to receive a digital video signal;
a protocol logic module, configured to perform protocol unpacking on the digital video signal to obtain a video code stream;
a first color space conversion module, configured to perform color space conversion on the video code stream;
a compression module, configured to perform lossless compression on the video code stream obtained by the color space conversion; and
a transmitting module, configured to transmit the video code stream obtained by the lossless compression, wherein
the receiver comprises:
a second receiving module, configured to receive the video code stream obtained by the lossless compression;
a decompression module, configured to decompress the video code stream obtained by the lossless compression;
a second color space conversion module, configured to perform color space conversion on the decompressed video code stream;
a transmitter logic module, configured to edit the video code stream obtained by the color space conversion to obtain a digital video signal conforming to a digital video signal protocol; and
an output module, configured to output the digital video signal, wherein
the transmitter and the receiver are connected via a data transmission medium.

10. The system according to claim 9, wherein the data transmission medium is any one of a transmission cable for a digital video signal, a network cable used for network connection and a chip having functions of cut-through and switching of high bandwidth data.
